(19) United States
(12) Patent Application Publication
(10) Pub. No.: US 2009/0323346 A1
(43) Pub. Date: Dec. 31, 2009

(54) LIGHT EMITTING DIODE STRUCTURE

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/239,834

(22) Filed: Sep. 29, 2008

(30) Foreign Application Priority Data
Jun. 25, 2008 (CN) 200810068114.4

(51) Int. Cl. F21V 29/00

(52) U.S. Cl. 362/294

(57) ABSTRACT

An exemplary light emitting diode (LED) structure includes a heat sink and a light emitting diode mounted on a top surface of the heat sink. The heat sink includes a first fin unit and a second fin unit facing the first fin unit. Each of the first fin unit and the second fin unit includes a main body and a plurality of fins extending outwardly from the main body. The first fin unit and the second fin unit are thermally connected to each other and electrically insulated from each other. The light emitting diode is mounted on a top surface of the heat sink. The light emitting diode is thermally connected with the first fin unit and the second fin unit. The light emitting diode has two electrodes being electrically connected to electrical layers formed on the first fin unit and the second fin unit, respectively.

### BACKGROUND

1. Technical Field

The present invention relates to a light emitting diode structure, and particularly to a light emitting diode structure having a better heat dissipation.

2. Description of Related Art

Presently, LEDs (light emitting diode) are preferred to be used in the non-emissive display devices instead of CCFLs (cold cathode fluorescent lamp) due to high brightness, long life-span, and wide color gamut of the LEDs.

A related LED structure includes a substrate, a LED chip disposed on the substrate and an encapsulation material encapsulated the LED chip on the substrate. The LED chip is electrically connected to the substrate via a gold wire. The substrate is flat plate and made of materials having high thermal conductivities. Heat generated by the LED chip is dissipated into a surrounding environment of the LED structure via the substrate.

Generally, the LED chip is made to be more powerful while maintaining a smaller size, and hot spot is accordingly formed between a contacting area of the LED chip and the substrate. Heat in the hot spot needs to be transferred to other portion of the substrate and further to be dissipated to the surrounding environment of the LED structure. However, the substrate has a small heat dissipation area for its flat-shaped nature. Therefore, the heat flux density between the hot spot and the other portion of the substrate is too large to enable the substrate to timely dissipate the heat generated by the LED chip.

For the foregoing reasons, therefore, it is desired to devise a LED structure which can overcome the above-mentioned problems.

### SUMMARY

The present invention relates to a light emitting diode structure. According to an exemplary embodiment of the present invention, the light emitting diode structure includes a heat sink and at least one light emitting diode mounted on a top surface of the heat sink. The heat sink includes a first fin unit and a second fin unit facing the first fin unit. Each of the first fin unit and the second fin unit includes a main body and a plurality of fins extending outwardly from the main body. The first fin unit and the second fin unit are thermally connected to each other and electrically insulated from each other. The at least one light emitting diode is mounted on a top surface of the heat sink. The at least one light emitting diode is thermally connected with the first fin unit and the second fin unit. The at least one light emitting diode has two electrodes being electrically connected to the first fin unit and the second fin unit, respectively.

Other advantages and novel features of the present invention will become more apparent from the following detailed description of embodiment when taken in conjunction with the accompanying drawings.

### BRIEF DESCRIPTION OF THE DRAWINGS

FIG. 1 is a cross-sectional view showing a light emitting diode structure in accordance with a first exemplary embodiment of the present invention.

FIG. 2 is an exploded, isometric view of a heat sink of the light emitting diode structure of FIG. 1.

FIG. 3 is a view similar to FIG. 2, but shown from a different aspect.

FIG. 4 is a cross-sectional view of a light emitting diode structure in accordance with a second exemplary embodiment of the present invention.

### DETAILED DESCRIPTION OF THE EMBODIMENTS

Reference will now be made to the drawings to describe the various present embodiments in detail.

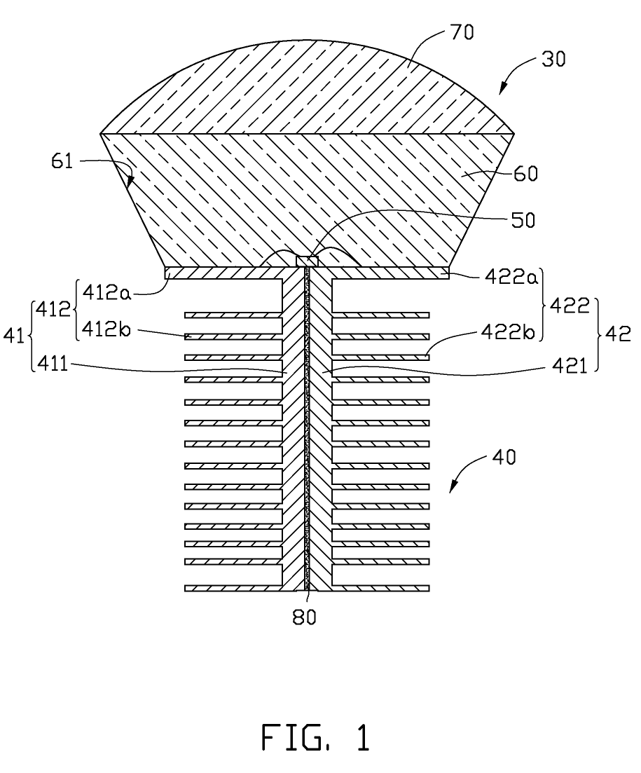

Referring to FIG. 1, a light emitting diode (LED) structure 30 in according to a first exemplary embodiment of the present invention includes a heat sink 40, a LED chip 50 mounted on a top surface the heat sink 40, an encapsulation material 60 on the heat sink 40 for protecting the LED chip 50, and a lens 70 on the encapsulation material 60.

The heat sink 40 is made of materials having electric and thermal conductivities. In this embodiment, the heat sink 40 is made of metal such as aluminum or copper. The heat sink 40 includes a first fin unit 41 and a second fin unit 42 facing the first fin unit 41.

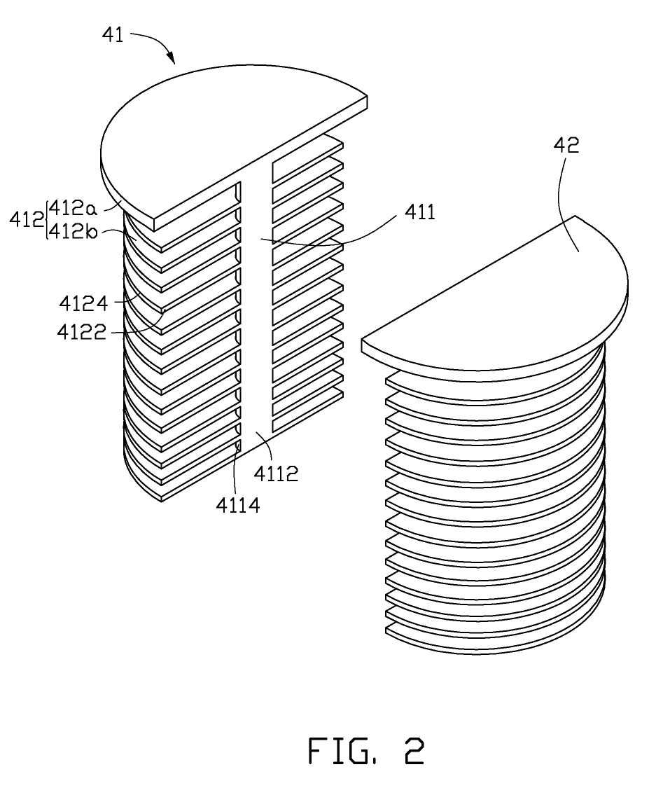

The first fin unit 41 includes a main body 411 and a plurality of fins 412 extending outwardly from an outer peripheral of the main body 411. Referring to FIG. 2, the main body 411 is half-columned. The main body 411 includes a rectangular planar side surface 4112 and a semicircular side surface 4114. Each of the fins 412 is a semicircular plate, which extends horizontally and outwardly from the semicircular side surface 4114 of the main body 411 and is perpendicular to the semicircular side surface 4114 of the main body 411. The fins 412 are parallel to and spaced from each other, and are arranged along an axial direction of the main body 411. The fins 412 include a first fin 412a located on a topmost end of the main body 411 and a plurality of second fins 412b located below the first fin 412a. Each of the fins 412 includes an inner side surface 4122 coplanar to the planar side surface 4112 of the main body 411 and an outer side surface 4124 surrounding and parallel to the semicircular side surface 4114 of the main body 411. The second fins 412b have the same thickness and the same radius. The outer side surfaces 4124 of the second fins 412b are located on a circumferential surface of an imaginary round column. The thickness and the radius of the first fin 412a are larger than the thickness and the radius of each of the second fin 412b. An electrical layer (not shown) for electrically connecting with one electrode of the LED chip 50 is formed on a top surface of the first fin 412a of the first fin unit 41.

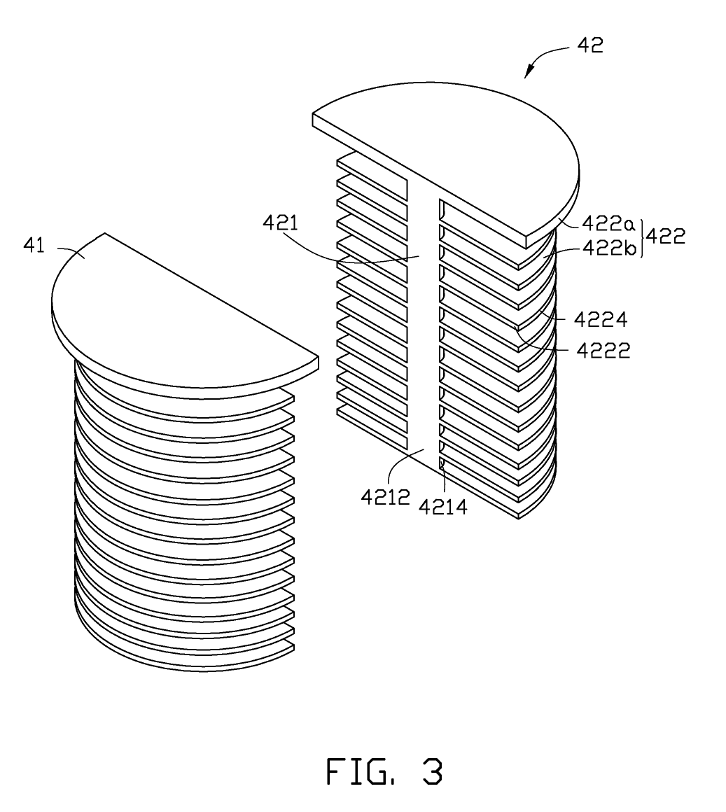

The second fin unit 42 is located at a right lateral side of the first fin unit 41, and faces the first fin unit 41. The first fin unit 41 and the second fin unit 42 are symmetrical to a center of the heat sink 40. Referring to FIG. 3, the second fin unit 42 includes a main body 421 and a plurality of fins 422 extending outwardly from an outer peripheral of the main body 421. The main body 421 is half-columned, which includes a planar side surface 4212 and a semicircular side surface 4214. The fins 422 include a first fin 422a located on a topmost end of the main body 421 and a plurality of second fins 422b located below the first fin 422a. Each of the fins 422 includes an inner side surface 4222 coplanar to the planar side surface 4212 of the main body 421 and an outer side surface 4224 surrounding and parallel to the semicircular side surface 4214 of the main body 421. An electrical layer (not shown) for electrically connecting with another electrode of the LED chip 50 is formed on a top surface of the first fin 422a of the second fin unit 42.

The encapsulation material 60 is made of light permeable material, such as glass, epoxy resin or etc. The encapsulation material 60 is located on the top surface of the heat sink 40 and mounts around the LED chip 50 for encapsulating the LED chip 50 therein. The encapsulation material 60 is substantially an inverted frustum, which includes a lateral side 61 inclined with respect to the top surface of the heat sink 40. A diameter of the encapsulation material 60 gradually increases from a bottom end towards a top end of the encapsulation material 60.

The lens 70 is made of transparent, light permeable materials, such as epoxy resin, glass, etc. In this embodiment, the lens 70 is made of glass material since glass material is resistant to high temperature, erosion, scratches and so on. The lens 70 is a convex lens having a convex top surface facing a surrounding environment of the LED structure 30. A bottom surface of the lens 70 is attached to a top surface of the encapsulation material 60. The lens 70 has a positive refracting power for converging light which is emitted from the LED chip 50 and transmits through the lens 70.

In assembly, the first fin unit 41 and the second fin unit 42 are assembled side-by-side together to form the heat sink 40. The planar side surface 4212 of the main body 421 of the second fin unit 42 faces the planar side surface 4112 of the main body 411 of the first fin unit 41, and the inner side surfaces 4222 of the fins 422 of the second fin unit 42 faces the inner side surfaces 4112 of the fins 411 of the first fin unit 41, respectively. A thermal interface material layer 80 (FIG. 1) is interconnected between the planar side surface 4112 of the main body 411 of the first fin unit 41 and the planar side surface 4212 of the main body 421 of the second fin unit 42. The thermal interface material layer 80 is formed by applying a layer of material having electric insulation and thermal conductivities, such as silica gel, on at least one of the planar side surface 4112, 4212 of the first fin unit 41 and the second fin unit 42. Thus, the first fin unit 41 is thermally connected with the second fin unit 42, and the first fin unit 41 is electrically insulated from the second fin unit 42.

The main body 411 of the first fin unit 41 and the main body 421 of the second fin unit 42 connect together to form a columned central pole of the heat sink 40, and the fins 41, 42 extend outwardly from the central pole. The first fin 412a of the first fin unit 41 and the first fin 422a of the second fin unit 42 connect together to form a discal substrate on the topmost end of the central pole of the heat sink 40. The LED chip 50 is mounted on a center of the discal substrate and locates just above the central pole. The electrical layers of the first fin unit 41 and the second fin unit 42 electrically connect with an external power supply (not shown), respectively, so that the LED chip 50 can electrically connect with the external power supply.

During operation, the LED chip 50 generates heat. Since both the metallic first fins 412a, 422a of the first and the second fin units 41, 42 are thermally contacted with the LED chip 50, the heat generated by the LED chip 50 is able to be conducted to the first fins 412a, 422a of the first and the second fin units 41, 42 fast and further be conducted to the main bodies 411, 421 and the second fins 412b, 422b of the first and the second fin units 41, 42. The heat is further dissipated to the surrounding environment via the larger heat dissipation area of the main bodies 411, 421 and the second fins 412b, 422b of the first and the second fin units 41, 42. Therefore, heat flux density between the LED chip 50 and the heat dissipation area of the heat sink 40 is decreased and heat dissipation effectiveness of this LED structure 30 is enhanced.

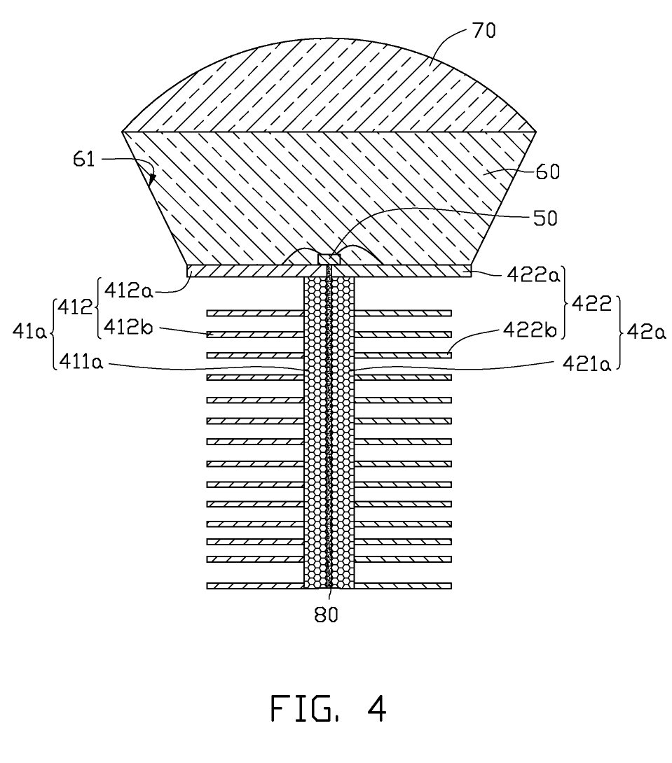

FIG. 4 shows a second embodiment of the LED structure. Except for the main bodies 411a, 421a of the first and the second fin units 41a, 42a, other parts of the LED structure in accordance with this second embodiment have substantially the same configurations as the LED structure 30 of the previous first embodiment. More specifically, the main body 411, 421 of each of the first fin unit 41 and the second fin unit 42 in this second embodiment defines a plurality of pores communicated with each other. The main body 411, 421 of each of the first fin unit 41 and the second fin unit 42 is a metal foam block, which is made of the same metal material as the fins 412, 422. The main body 411 and the fins 412 of the first fin unit 41, the main body 421 and the fins 422 of the second fin unit 42 are integrally formed as a single piece, respectively. Alternatively, the main body 411, 421 of each of the first fin unit 41 and the second fin unit 42 can be made of other porous material. For example, the main body 411, 421 of each of the first fin unit 41 and the second fin unit 42 can be made from sintering metal powders such as copper powders, ceramic powders, etc, and the main body 411, 421 and the fins 412, 422 of each of the first fin unit 41 and the second fin unit 42 can be molded separately and then be affixed to each other.

It is to be understood, however, that even though numerous characteristics and advantages of the present invention have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode structure comprising:
a heat sink comprising a first fin unit and a second fin unit facing the first fin unit, each of the first fin unit and the second fin unit comprising a main body and a plurality of fins extending outwardly from the main body, the first fin unit and the second fin unit being thermally connected to each other and electrically insulated from each other; and
at least one light emitting diode mounted on a top surface of the heat sink, the at least one light emitting diode being thermally connected with the first fin unit and the second fin unit, the at least one light emitting diode having two electrodes being electrically connected to the first fin unit and the second fin unit, respectively.

2. The light emitting diode structure of claim 1, wherein the main body of each of the first fin unit and the second fin unit is half-columned, and the fins extend outwardly from an outer side surface of the main body and are perpendicular to the outer side surface of the main body.

3. The light emitting diode structure of claim 2, wherein the fins of each of the first fin unit and the second fin unit are parallel to and spaced from each other, and are arranged along an axial direction of the main body, each of the fins being a semicircular plate.

4. The light emitting diode structure of claim 2, wherein the fins of each of the first fin unit and the second fin unit comprise a first fin located on a topmost end of the main body and a plurality of second fins located below the first fin, a radius of the first fin is larger than a radius of each of the second fins, and a thickness of the first fin is larger than a thickness of each of the second fins.

5. The light emitting diode structure of claim 4, wherein the second fins have the same thickness and the same radius.

6. The light emitting diode structure of claim 4, wherein the main body of each of the first fin unit and the second fin unit comprises a rectangular planar side surface and a semicircular side surface, each of the second fins comprises an inner side surface coplanar to the planar side surface of the main body and an outer side surface surrounds and parallel to the semicircular side surface of the main body, and the outer side surfaces of the second fins are located on a circumferential surface of an imaginary round column.

7. The light emitting diode structure of claim 4, wherein the first fin of the first fin unit and the first fin of the second fin unit cooperatively form a discal substrate, the at least one light emitting diode comprises one light emitting diode mounted on a center of the discal substrate, and a thermal interface material layer is applied between the first fin unit and the second fin unit.

8. The light emitting diode structure of claim 1, wherein the main body of each of the first fin unit and the second fin unit defines a plurality of pores communicated with each other.

9. The light emitting diode structure of claim 8, wherein the main body of each of the first fin unit and the second fin unit is made of one of metal foam and sintered metal powder.

10. The light emitting diode structure of claim 1, wherein the first fin unit and the second fin unit are symmetrical to a center of the heat sink.

11. The light emitting diode structure of claim 1, further comprising a lens locates above the at least one light emitting diode chip, the lens has a positive refracting power for converging light which is emitted from the light emitting diode and transmits through the lens.
